(19) United States
(12) Patent Application Publication
(10) Pub. No.: US 2006/0064363 A1
(43) Pub. Date: Mar. 23, 2006

(54) Financial Planning Method and System

(76) Inventor: Phillip A. Schwegmann, Cincinnati, OH (US)

Correspondence Address: LAFKAS PATENT LLC, 7811 LAUREL AVENUE, CINCINNATI, OH, 45243, US

(21) Appl. No.: 10/711,243

(22) Filed: Sep. 3, 2004

(51) Int. Cl. G06Q 40/00

(52) U.S. Cl. 705/35

(57) ABSTRACT

The present invention is a method and system for determining a symbolic rating from comparing an investor's current investment value to a investment value that the investor should possess at the current time in order to achieve a desired future investment worth, and transmitting the symbolic rating to the investor.

### BACKGROUND OF THE INVENTION

This invention relates to a system and method for financial planning, and more particularly, to a system and method for evaluating current investment positions in view of projected future financial situations.

Typically, the most drastic planned financial change for an individual occurs at the age of retirement from the active workforce. Many investors plan their respective investment strategies and risk-abilities based on a standard of living to which they have grown accustomed or wish to improve upon at retirement.

Investors may consult professional investment counselors to determine what their respective economic target should be at a future date such as retirement. Such counselors can assist in analyzing factors such as inflation, taxes, economic trends, and the like to determine the economic target of an investor wishing to retain and/or improve a standard of living at a later date.

Usually investors will diversify their investments into any of a number of different speculations such as savings, real estate, stocks and bonds, insurance policies, etc. An investor and his/her investment counselor may have an idea of how each of the individual investments is performing individually and/or what the overall value of the investments is, but may not see the larger picture of how the overall investment strategy is leading to a determined economic target to attain a desired level of economic comfort at retirement and/or other desired future time.

Further, an investor may receive a monthly statement indicating gains and/or losses in different investments monitored by his/her investment counselor, but the bottom-line value of the investment, even if a gain, may not present to the investor as to whether or not his investment strategy is as successful as it should be to attain his desired economic target. The investor could contact his/her investment counselor to discuss whether the investment strategy is working; however, this takes additional time on the part of all involved parties, and requires additional communications.

Thus, what is needed is a simple means of conveying to an investor on a regular basis how the present value and strategy of his investment portfolio is achieving his/her desired future economic target.

### SUMMARY OF THE INVENTION

The various exemplary embodiments of the present invention includes a system for generating information representative of a current financial portfolio relative to a future financial position of one or more investors, the system comprising a computing device including one or more processing means for processing data and one or more storing means for storing data, one or more inputting means for inputting criteria information representative of the current financial portfolio and information representative of the future financial position of the one or more investors, one or more initializing means for generating the current financial portfolio based on the criteria information input and for generating a relative future financial position based on a reverse extrapolation of the future financial position, calculating means for mathematically comparing the current financial portfolio to the relative future financial position and determining a discrete symbolic rating, and one or more transmitting means for presenting the discrete symbolic rating to the one or more investors.

The various exemplary embodiments of the present invention further includes a method for generating information representative of a current financial position relative to a future financial position of one or more investors, the method comprising inputting criteria information representative of the current financial portfolio and information representative of the future financial position of the one or more investors into a computing device, generating the current financial portfolio based on the criteria information via one or more processing means of the computing device, generating a relative future financial position via the one or more processing means based on the future financial position input into the computing device, determining a discrete symbolic rating of a mathematical comparison between the current financial portfolio and the relative future financial position, and transmitting the discrete symbolic rating to the one or more investors.

### BRIEF DESCRIPTION OF THE DRAWINGS

The various exemplary embodiments of the present invention, which will become more apparent as the description proceeds, are described in the following detailed description in conjunction with the accompanying drawings, in which:

FIG. 1 is a schematic illustration of a flowchart of an exemplary method according to the various exemplary embodiments of the present invention.

### DETAILED DESCRIPTION

The various exemplary embodiments of the present invention include a system for generating a discrete symbolic rating defining a relationship between a current financial portfolio and a desired future financial position.

In the various exemplary embodiments, the current financial portfolio of one or more users may comprise any of a number of criteria. Such criteria comprising the current financial portfolio may include salary, savings, social security, then-present pension value, 401 K investment value, IRA value, stock and bond then-current value, residential and commercial real estate value held by the one or more investors, intellectual property value as owned and preferably protected by the one or more investors, other personal and investment property held by the one or more investors, debt of the one or more investors, then-current tax implications, and the like.

The “current” value of each and any of the above-identified and like income and investment streams may be a “snap-shot” value, that is, for example, an actual property value at a particular instant in time. For example, a value of a stock investment may be fluid. Thus, for the embodiments of the present invention, the value of the stock investment and like one or more fluid investments may be determined at a single moment in time, for example, the value of the investment at the close of business on a certain date.

The criteria of the current financial portfolio may be an average value of the income and/or investment over a interval of time. That is, for example, the value of one or more fluid incomes and/or investments may be determined as an average value over a predetermined interval of time, for example, one month.

Further, it should be understood that the income and investment values may be estimates in some situations. For example, a piece of real estate may have an estimated value that is not vested until sold to another person or entity. Thus, for the embodiments of the present invention, reasonably estimated investment values may be input as criteria of the current financial portfolio.

In a preferred exemplary embodiment of the present invention, the one or more investors consult with an experienced professional investment manager to determine accurate and precise values of the criteria of the current financial portfolio.

The future financial position comprises an estimated income, savings and the like that the one or more investors intend on possessing at a future time, for example, at retirement, in order to maintain and/or improve the standard of living desired by the one or more investors.

In a preferred embodiment of the present invention, the one or more investors consult with an experienced professional investment manager who is able to determine the standard of living desired by the one or more investors at the future time. The standard of living desired by the one or more investors may comprise considerations including desired housing, travel, medical, insurance, donations, gifts potential and/or expected inheritance and the like on the part of the one or more investors. Based in part on the standard of living desired by the one or more investors, and on estimated future taxes, medical costs, etc., the investment manager may more accurately and precisely determine the future financial position of the one or more investors.

Thus, the future financial position may be considered in part as an estimated financial goal to which the one or more investors are trying to achieve.

A relative future financial position is the value that the one or more investors should ideally possess at a current time in order to achieve the future financial position, assuming a consistent trend of investment gains to the point in time deemed to be the future time of the one or more investors.

In the various exemplary embodiments, the current financial portfolio is related to the future financial position via the relative future financial position to determine the discrete symbolic rating. The discrete symbolic rating is a means by which the one or more investors is provided with a simple understanding of how their current financial portfolio is developed and/or developing in view of their future desired financial position.

That is, the various exemplary embodiments of the present invention provides the one or more investors a simple graded evaluation of their then-current economic standing in light of a their desired economic target outlook. The simple graded evaluation may then be used by the one or more investors as a first step in determining whether or not their investment strategy and financial risk assessment needs to be modified to better match their future economic goals and desires.

For example, if the current financial portfolio is not presently in a position or extrapolated trend wherein the future financial position may be realistically achieved, the discrete symbolic rating indicates and should be understood by the one or more investors that the criteria of the current financial portfolio should be reassessed to determine which investments and financial planning should be modified in order to have the current financial portfolio and the future financial position be more in line with each other.

However, in an example wherein the discrete symbolic rating indicates that the standing of the current financial portfolio is in line with attaining or surpassing the future financial position, the one or more investors understands that their current financial investment model probably does not need to be modified.

The discrete symbolic rating of the various exemplary embodiments may comprise a letter grade, a numeric value, a unique set of figures, and combinations thereof.

In the exemplary embodiment wherein the discrete symbolic rating is a letter grade, the letter grade may comprise a traditional “A” through “F” grade based on the performance of the criteria of the current financial portfolio relative to the future financial position. The letter grade may further comprise pluses and minuses to even further narrow and/or define the letter grade given.

The exemplary embodiments wherein the symbolic rating is a numerical value may comprise a range of numbers, for example, between about 0 and 100, a percentage value, fractional value, and a ratio.

The discrete symbolic rating comprising a unique set of figures in the various exemplary embodiments may include, for example, a checkmark or series thereof; a set of rating symbols such as, for example, a number of stars, wherein the number of stars indicates the ability of the current financial portfolio to develop into the future financial position; and other like symbolic rating.

In a preferred exemplary embodiment, the discrete symbolic rating is a numeric value between about 0 and about 1. A value of about 0 in this preferred exemplary embodiment indicates that the current financial portfolio will not achieve the future financial position at the current investment trend without modification to the criteria of the current financial portfolio. A value of about 1 in this preferred exemplary embodiment indicates that the current financial portfolio should achieve the future financial position at the current investment trend.

The system according to the various exemplary embodiments of the present invention comprises one or more computing devices. The one or more computing devices may be, for example, a personal and/or mobile computer, a computer server, or combinations thereof. The one or more computing devices of the various exemplary embodiments comprises one or more processing means and one or more storing means for the manipulation and storage of data via the one or more computing devices.

In addition to the one or more computing means, the system of the various exemplary embodiments of the present invention comprises one or more input means. The input means allows for the introduction of data to the one or more computing devices and preferably stored subsequently into the one or more storing means.

The system further comprises a transmitting means for providing the discrete symbolic rating determined by the processing means based upon the criteria of the current financial portfolio and future financial position as provided with the inputting means.

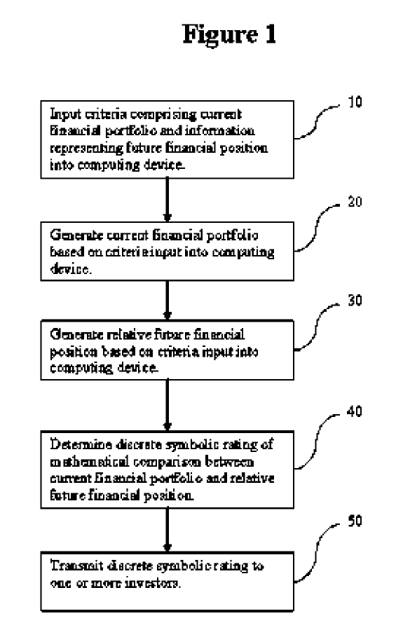

An exemplary embodiment of the method according to the present invention is shown in FIG. 1. The method comprises defining and inputting 10 the one or more investor's criteria comprising the current financial portfolio into the computing device the inputting means. The inputting means according to the various exemplary embodiments comprises a keyboard, mouse, electronic touch pad, and the like. The current financial portfolio is generated 20 on the criteria input.

The relative future financial position is then generated 30 based upon the predetermined future financial position and consistent trends in value gains. Preferably, the one or more investors consult with an investment manager to determine more accurate determinations. The future financial position is then entered into the system via the inputting means.

The relationship between the current financial portfolio and the future financial position is then assessed to determine 40 and provide the discrete symbolic rating.

In assessing the relationship between the current financial portfolio and the future financial position, the present monetary value of the criteria is related to the related future financial position in the form of a ratio, a fraction, percentage, etc. Upon assessing the discrete symbolic rating, the rating is transmitted 50 to the one or more clients. Transmitting the rating to the clients may comprise forwarding the rating in a monthly statement, over the Internet, via the telephone, and in person. Preferably, transmitting the rating comprises forwarding the rating in a monthly statement, via the Internet, and combinations thereof.

In a first example, an investor may have a current financial portfolio worth of $800,000. This current financial portfolio takes into account the investor's current salary, savings, residential real estate value, current value of a 401 K pension plan, and potential social security earnings. In meeting with an investment counselor, it is determined that the investor should have a net worth of $1.7 million at retirement in order to remain at a similar standard of living as the investor is currently living at. By extrapolating the desired $1.7 million back to current value based on market trends and known accounting and investing methods, it may be determined that the investor should have a relative future financial position of $860,000 at the current time in order to realistically achieve the $.17 million in worth at retirement.

Thus, the current portfolio value of $800,000 is compared to the relative future financial position of $860,000. The discrete symbolic rating of this exemplary current financial portfolio to the relative future financial position, is a ratio of 1:1.075, a percentage of 93%, and a fractional value of 40/43. Thus, the investor has a relatively good investment strategy as she is close to having a 1:1 ratio and/or a 100% current value compared to what would be desired at this time to earn the future financial position. From this determination, the investor has a quick overall financial picture and has a better idea of whether or not to modify her current financial investment strategy.

In another exemplary example, an investor may have a current financial portfolio worth of $300,000. Based on a determination of an investment counselor, a future financial position of $900,000 is desired to be attained by the investor by the age of retirement. It is also determined that a relative future financial position of $500,000. Based on these numbers, the investor has a discrete symbolic rating of 0.60.

In this example, a discrete symbolic rating of 1.0 is what would be achieved if the current financial value and the relative future financial position were the same, and thus the investment strategy of the investor would be on target to achieve the future financial position. However, the discrete symbolic rating is much below 1.0, and therefore should be a sign to the investor that his investment strategy is not producing the desired results overall and needs to be reassessed.

While this invention has been described in conjunction with the specific embodiments outlined above, it is evident that many alternatives, modifications and variations will be apparent to those skilled in the art. Accordingly, the preferred embodiments of the invention as set forth above are intended to be illustrative, not limiting. Various changes may be made without departing from the spirit and scope of the invention.

What is claimed is:

1. A system for generating information representative of a current financial portfolio relative to a future financial position of one or more investors, the system comprising:
a computing device including one or more processing means for processing data and one or more storing means for storing data;
one or more inputting means for inputting criteria information representative of the current financial portfolio and information representative of the future financial position of the one or more investors;
one or more initializing means for generating the current financial portfolio based on the criteria information input and for generating a relative future financial position based on a reverse extrapolation of the future financial position;
calculating means for mathematically comparing the current financial portfolio to the relative future financial position and determining a discrete symbolic rating; and
one or more transmitting means for presenting the discrete symbolic rating to the one or more investors.

2. The system according to claim 1, wherein the criteria information representative of the current financial position is selected from the group consisting of income, savings, real estate, bonds, stocks, pension investment, social security, taxes, inheritance, gifts, personal property, intellectual property, debt, and combinations thereof.

3. The system according to claim 1, wherein the information representative of the future financial position is selected from the group consisting of income, savings, real estate, bonds, stocks, pensions, social security, taxes, inheritance, gifts, personal property, intellectual property, debt, insurance, medical costs, and combinations thereof.

4. The system according to claim 1, wherein the discrete symbolic rating is a letter grade, a numeric value, a unique set of figures, or combinations thereof.

5. The system according to claim 4, wherein the discrete symbolic rating is a numeric value between about 0 and about 1.

6. The system according to claim 4, wherein the discrete symbolic rating is a numeric ratio.

7. The system according to claim 1, wherein the computing device is a personal computer.

8. The system according to claim 7, wherein the personal computer is connected to the Internet.

9. The system according to claim 1, wherein the transmitting means is a monthly statement forwarded to the one or more investors.

10. The system according to claim 1, wherein the transmitting means is one or more transmissions via the Internet.

11. A method for generating information representative of a current financial position relative to a future financial position of one or more investors, the method comprising:
inputting criteria information representative of the current financial portfolio and information representative of the future financial position of the one or more investors into a computing device;
generating the current financial portfolio based on the criteria information via one or more processing means of the computing device;
generating a relative future financial position via the one or more processing means based on the future financial position input into the computing device;
determining a discrete symbolic rating of a mathematical comparison between the current financial portfolio and the relative future financial position; and
transmitting the discrete symbolic rating to the one or more investors.

12. The method according to claim 11, wherein the criteria information representative of the current financial position is selected from the group consisting of income, savings, real estate, bonds, stocks, pension investment, social security, taxes, inheritance, gifts, personal property, intellectual property, debt, and combinations thereof.

13. The method according to claim 11, wherein the information representative of the future financial position is selected from the group consisting of income, savings, real estate, bonds, stocks, pensions, social security, taxes, inheritance, gifts, personal property, intellectual property, debt, insurance, medical costs, and combinations thereof.

14. The method according to claim 11, wherein the discrete symbolic rating is a letter grade, a numeric value, a unique set of figures, or combinations thereof.

15. The method according to claim 14, wherein the discrete symbolic rating is a numeric value between about 0 and about 1.

16. The method according to claim 14, wherein the discrete symbolic rating is a numeric ratio.

17. The method according to claim 11, wherein the computing device is a personal computer.

18. The method according to claim 11, wherein the personal computer is connected to the Internet.

19. The method according to claim 11, wherein transmitting is via a monthly statement forwarded to the one or more investors.

20. The method according to claim 11, wherein transmitting is via the Internet.
